(19) United States
(12) Patent Application Publication
(10) Pub. No.: US 2018/0197293 A1
(43) Pub. Date: Jul. 12, 2018

(54) METHOD OF IMAGE SEGMENTATION

(71) Applicant: COMPAGNIE GENERALE DES ETABLISSEMENTS MICHELIN, CLERMONT-FERRAND (FR)

(72) Inventors: VINCENT ARVIS, Clermont-Ferrand (FR); JOHN CHAUSSARD, Clermont-Ferrand (FR); MICHEL BILODEAU, Clermont-Ferrand (FR)

(21) Appl. No.: 15/736,574

(22) PCT Filed: Jun. 28, 2016
(86) PCT No.: PCT/FR2016/051599

§ 371 Date: Dec. 14, 2017

(30) Foreign Application Priority Data
Jun. 29, 2015 (FR) 1556080

(51) Int. Cl. G06T 7/155

(52) U.S. Cl. CPC G06T 7/155; G06T 2207/30248

(57) ABSTRACT

The invention relates to a method of segmenting an image, representative of an object whose external surface exhibits relief patterns, into a first zone comprising patterns and a second zone not comprising any, the method comprising the following steps:
A thresholding step in the course of which the grey level image is transformed into a binary image,
A step of evaluating the number of patterns on each line of the image, and
A step in the course of which, as a function of the results of the previous steps which make it possible to obtain a number of patterns in the image, a first set of pixels of the image representing patterns is determined.

### FIELD OF THE INVENTION

The invention relates to the field of the visual checking of manufactured products whose external surface exhibits elements in relief. This invention can be applied in particular, but not exclusively, to products exhibiting periodic patterns, for example tires.

This visual checking makes it possible, for example, to detect possible surface defects resulting from fabrication. At the present time, visual inspection and usually calls upon the dexterity of the operators responsible for detecting these possible imperfections visible on the surface of objects. However, with advances in the processing power of computing means, manufacturers are now glimpsing the possibility of automating these checking tasks.

For this purpose, various lighting and digital imaging means are therefore used to acquire images, with a view to subsequent digital processing making it possible to detect imperfections previously detected visually by operators. These imaging means make it possible to perform various captures of images, be it in two dimensions or in three dimensions, of the interior and/or exterior surface of the tire to be inspected.

In the case of objects exhibiting certain zones on which relief patterns are present, it is useful to be able to apply different processings to the zones with patterns, and to the zones without patterns. For this purpose, it is useful to be able to differentiate, on an image of a tire, the various zones that are present.

Various techniques aimed at performing such differentiation are known, but none exhibits sufficient robustness to be able to be applied to a wide range of manufactured products. Furthermore, the known solutions exhibit processing times that are too long to be acceptable in an industrial environment.

The present invention is therefore aimed at proposing a segmentation solution making it possible to remedy the above-mentioned drawbacks.

### GENERAL DESCRIPTION OF THE INVENTION

The present invention is therefore aimed at proposing a method making it possible to segment an image of the external surface of a manufactured product so as to distinguish the zones of the image exhibiting relief patterns, from the other zones.

Thus, the present invention relates to a method of segmenting an image, representative of a manufactured product whose external surface exhibits relief patterns, into a first zone comprising patterns and a second zone not comprising any, the method comprising the following steps:
A thresholding step in the course of which the grey level image is transformed into a binary image,
A step of evaluating the number of patterns on each line of the image, and
A step in the course of which, as a function of the results of the previous steps which make it possible to obtain a number of patterns in the image, a first set of pixels of the image representing patterns is determined.

Hereinafter in the patent application, an image on which a method in accordance with the invention is applied will sometimes be referred to by the expression “input image”.

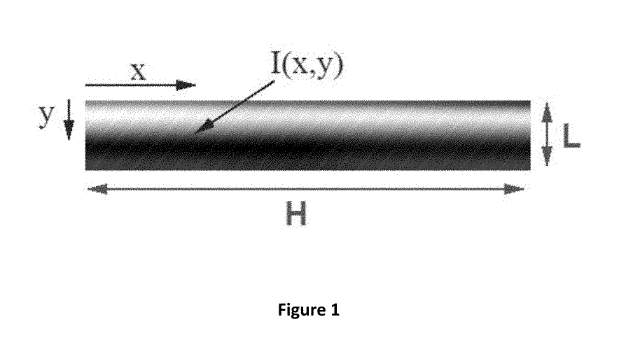

By convention, throughout the patent application, the notations shown in FIG. 1 will be used. Thus, the notations L and H will be used respectively for the width and the height of an input image, and the point I(x,y) will be referenced in the reference frame (x,y) shown in this FIGURE.

It has been found that certain input images possessed a curvature along the lines and columns. This curvature appears on measuring the average of the lines and columns of the image: each line, and each column of the image, possesses a different average, correlated with its position in the image. This effect, due to the natural curvature of the tire, (which differs according to the type of tire) as well as to the mechanical stresses undergone by the tire during its acquisition, must be corrected before any other processing, so that all the elements of the tire have a comparable height whatever their position in the tire.

For this purpose, in a particular embodiment, the method comprises an initial step in the course of which the image is rendered flat.

In an exemplary embodiment, this step of rendering the image flat comprises a step of detecting a carrier signal on which the patterns lie. Accordingly, a simple moving average is carried out along the lines: at each pixel of the cleaned image the average of the neighbouring pixels (situated less than a certain distance away) and situated on the same line is calculated; this value is thereafter deducted from the pixel.

These operations can be defined in the following manner: Let I be a two-dimensional image, and r a positive integer, the operation AvgSub is defined to be a function taking a two-dimensional image I as input and producing an image of the same size as output

AvgSubᵣ(I)(x,y)=I(x,y)−p({I(i,y)|i∈[0,L(I)] and

min(|x−i),L(I)−|x−i)≤r))

The operation consists in calculating, in a horizontal window of size 2r+1 centred on the pixel (x; y), (by considering the specific feature, expressed by the minimum, of stitching together the right and left edges), the average of the pixels, and deducting this average from the value of the pixel (repeating this for all the pixels of the image).

The method of segmentation of the present invention could also be used on images representing all types of object, and not necessarily tires. In this case, the step of rendering flat would not turn out to be definitely useful since, in the case of a tire, it is made necessary because of the rounded shape of the object.

In a preferential manner, the image rendered flat, that we shall henceforth call the “flat image”, is obtained by subtracting the minimum of the image from this average value so as to obtain solely positive values. For the latter operation, a radius is advantageously chosen which makes it possible to preserve the patterns while removing the carrier. Furthermore, it turns out that, although carried out solely on the lines of the image, this operation also makes it possible to circumvent the curvature along the columns of the image.

Once the input image has been rendered flat, the following step of the method consists in performing a thresholding operation, so as to transform the flat image, which is in grey levels, into a binary thresheld image. This makes it possible to create an output mask comprising as a first set of pixels containing the patterns, and a second set of pixels comprising the other elements.

To decide whether a pixel belongs to the output mask, three criteria are verified:
The first two consist in calculating on the one hand the average of the grey levels of the set of pixels of the line (respectively of the column) on which a pixel is situated, on the other hand the standard deviation, and to add these two values together.
The third criterion consists in verifying that the pixel belongs to a valid line, that is to say a line which is not too close either to the top, or to the bottom of the image; or a line which does not contain too large a number of outlier values, or else again a line which is not too close to a line containing a large number of outlier values.

As a function of the output mask thus defined, it is then possible to detect, in the image rendered flat, the lines in which patterns are present. On completion of this detection, a one-dimensional image is obtained, of the same size as the height of the flat image.

This detection step is performed in the following manner:
the variance of the grey levels of the pixels not belonging to the binary thresheld image is calculated, for each line of the image rendered flat, this amounting to excluding the patterns possible,
the calculation is performed a second time while horizontally expanding the thresheld image, this amounting to excluding more pixels from the calculation.

The lines on which patterns are present in the flat image will exhibit a very different result from the other lines. Indeed, the variance calculation performed excludes the cast shadow phenomenon caused by the patterns, this leading to low values with respect to the average. Thus, the lines comprising patterns will exhibit a large difference between the two variance values, whilst such is not the case for the lines with no striation.

The ratio between the two variance values thus calculated is then computed for each line. If this ratio becomes greater than a predetermined threshold, it will be considered that the line comprises a striation.

It is remarked here that a specific feature of relief patterns, namely the cast shadow phenomenon, is used to detect them. Other schemes could be envisaged for carrying out this detection step, however it has been found that the scheme described here provided the best results.

It should be noted once more that this step of detecting patterns is useful only for certain types of manufactured objects. Indeed, in the case where the patterns are present on only a part of the product, it is necessary to detect, on an image representing the product, the lines which actually contain patterns.

The following step, in a method in accordance with the invention, consists in evaluating the number of patterns on each line. Accordingly, the following steps are implemented:
firstly, the variance is calculated along each of the columns of an input image, so as to construct a one-dimensional image possessing a similar regularity to the patterns. According to the examples, the flat image or the thresheld image will be chosen as input image.
Two successive Fourier transforms are applied to this one-dimensional image so as to obtain a decomposition of the image in the frequency space,
one or more maxima of the decomposed image is or are then sought. Indeed, if an abscissa value x is high, this signifies that in the image there is a pattern which repeats itself every x pixels. Consequently a maximum of the image can correspond to a period of patterns.

However, it has been found that in certain cases, a maximum of the decomposed image does not correspond to a sought-after period of the patterns, but to a harmonic, that is to say a value due to a group of patterns which repeats itself regularly in the image. Consequently it is useful, in a particular embodiment, to look at the fractions of the determined maximum to detect possible candidates for the period of the patterns.

In a last step of a method according to the invention, the best components that could be patterns are detected in the thresheld image, and they are retained in a Result set. Accordingly, the adjoining components of the thresheld image are traversed by decreasing size, and they are retained if two conditions are complied with:
Firstly, it is not necessary that the adjoining component, if it was added to the Result set, should lead to there being on a line of the thresheld image a greater number of elements of the Result set than the number of patterns that was detected in the previous step, and
It is necessary furthermore that the adjoining component should belong to a valid line such as defined in paragraph [0019].

On completion of the latter step, a first pixel set is then obtained, corresponding to the Result set, comprising the set of patterns of the image.

However, it has been found that the Result set could, in certain cases, comprise supernumerary elements, which it would be useful to remove. For this purpose, in one embodiment, a method according to the invention furthermore comprises the following steps:
a step of re-evaluating the number of patterns in the image, and
a step of filtering the determined set of pixels, as a function of the re-evaluated number of patterns, so as to obtain a second set of pixels of the image.

In another embodiment, a method according to the invention furthermore comprises a step in the course of which empty spaces of the image are filled in so as to obtain a third set of pixels of the image.

In one embodiment, a method according to the invention comprises a step in the course of which supernumerary components are eliminated from the third set of pixels so as to obtain a fourth set of pixels of the image representing patterns.

It has been found that slight noise present in the image to which the method is applied could disturb the detection of the patterns, and thus lead to poor segmentation. To remedy this, in one embodiment, it is useful to provide a prior step of cleaning the image with morphological filters. Let us consider, in a particular example, an image where the topography of a tire is represented, that is to say that the value of each pixel of the image represents the height of the neighbourhood of the corresponding point in the tire. In such an image, the high grey level values indicate pixels of high altitude, while the low grey level values indicate pixels of low altitude. Thus, the patterns present on a tire resemble, in a topographical image, extended mountain chains, without necessarily being very high, while the noise present in the image appears in the form of a spike of very (mountains) or very low (canyons) altitude but of small size.

The objective of the present step is therefore to remove these spikes in value. For this purpose, use is made of a morphological opening, which consists in removing all the narrow mountains, whatever their altitude, followed by a morphological closing which consists in removing all the narrow canyons, whatever their depth.

The opening operation consists firstly in replacing the value of each pixel of the image with the minimum value of the pixels situated in a certain neighbourhood, and then in recommencing the operation, this time taking the maximum value. The closing operation consists in carrying out the same two operations, but in reverse (firstly the maximum value, and then the minimum value). The chosen neighbourhood consists of the set of pixels situated on the same line. as the pixel studied (one then speaks of opening and closing by a linear structuring element) and at a distance less than a certain threshold.

A threshold value making it possible to eliminate, on each line, mountains and canyons of small size, is preferentially chosen. However, this choice of radius must represent a compromise between too low a value which would not allow correct cleaning, and too high a value which could lead to the removal of certain elements of interest of the patterns.

### DESCRIPTION OF THE BEST EMBODIMENT

The detail of each of the steps of the scheme will be described hereinafter in the case of a specific product, namely a tire. In the description of this embodiment, the relief patterns will be called striations. In this example, the cleaning step is performed beforehand. Thus, if the starting image is named CEA, the cleaned image will be:

$$Clean = ∈ {{H}^{•}}_{8} ( {γ}_{8}^{{H}^{•}} ( CEA ) ) \qquad ( 1 )$$

As described previously in this text, the step of rendering flat is performed using an operation AvgSub and

AvgSubᵣ(I)(x,y)=I(x,y)−μ({I(i,y)|i∈[0,L(I)[ and

min(|x−i),L(I)−|x−i)≤r))

The following calculation is then performed: in a horizontal window of size 2r+1 centred on the pixel (x; y), the average of the pixels is calculated, and to deduct the latter from the value of the pixel (repeating this for all the pixels of the image). In a preferential manner, the image rendered flat, which we will henceforth call the “flat image”, is obtained by subtracting the minimum of the image from this average value to obtain solely positive values:

Flat=AvgSub₁₀₀(Clean)−min(AvgSub₁₀₀(Clean)) (2)

The calculation of the thresheld image is performed in the following manner:
a function is constructed which makes it possible to allocate a label to each line y of the input image. If an input mask PNM is considered, representing the outlier values of the input image (the pixels of outlier value are at A, and the others are at 0, and two stages are undertaken: firstly, a first temporary one-dimensional image is defined, of the same size as the height of the input images, and such that:

$${Line}_{—} tmp ( y ) = \{ \begin{matrix}{Line}_{—} {NOTOK}_{—} PNM if y < 10 or H ( PNM ) - y \leq 10 \\ {Line}_{—} {NOTOK}_{—} PNM if \frac{[ PNM ( x , y ) ]}{L ( PNM )} > 5 \% \\ {Line}_{—} OK otherwise \end{matrix}$$

The first condition makes it possible to mark as invalid the first ten and the last ten lines of the image, and the second condition makes it possible to mark as invalid all the lines possessing more than 5% of pixels marked as outliers in the image PNM.
We put Line_NOTOK_PNM=0 and Line_OK=2. The image Line, which will give us the label of each line, is obtained by propagating the labels of invalid lines, by virtue of an erosion, as follows:

Line=C₂₀⁸(Line_tmp) (3)
It is then possible to define the output mask by carrying out a threshold based on our previously defined criteria and on the labelling of the lines, on the basis of the image previously rendered flat (see equation 2)
This formula produces at output a mask of size equal to the size of the images at input, and where a pixel will be present if it is on a valid line (first condition), if its value is greater than the average plus the standard deviation of the pixels of the same line as it (second condition), and if its value is greater than the average plus the standard deviation of the pixels of the same column as it (third condition).

The step of detecting lines comprising striations is performed in the following manner:
We begin by calculating, for each line y of the image rendered flat (see equation 2), the variance of the pixels not belonging to the thresheld image, and the variance of the pixels not belonging to the expanded thresheld image of 60 pixels:

$$V ( y ) = Var ( ( Flat ( x , y ) \vert Thresh ( x , y ) = 0 ) )$$

$${V}_{δ} ( y ) = Var ( ( Flat ( x , y ) \vert {δ}_{60}^{{H}^{•}} ( Thresh ) ( x , y ) = 0 ) )$$

As explained previously, the ratio between these two values is calculated, in a new one-dimensional image Score, of size equal to the height of the input images. The ratio between the two values is also calculated in the one-dimensional image Ratio, but while undertaking cleaning with the aid of openings and closings, in the following manner:

$$Score ( y ) = \frac{V}{{V}_{a}} \\ Ratio ( y ) = \frac{{φ}_{10}^{H} ( γ Ib ( V ) )}{{φ}_{10}^{H} ( γ Ib ( {V}_{a} ) )} \qquad ( 5 )$$

We shall employ the image Ratio hereinafter in this section, whereas we shall employ the image Score in the following sections. For each valid line of the image, a search is conducted (by employing the image Line defined in equation 3), for the two extrema of values of Ratio.

$${min}_{—} Ratio = {min}_{\begin{matrix}l ∈ [ 0 , H ( Flat ) ] \\ Line ( l ) = {Line}_{—} OK\end{matrix}} Ratio ( l )$$

$${max}_{—} Ratio = {max}_{\begin{matrix}l ∈ [ 0 , H ( Flat ) ] \\ Line ( l ) = {Line}_{—} OK\end{matrix}} Ratio ( l )$$

After much experimentation, we have established that the variance ratio threshold which acts as limit is 1.5: if the value min Ratio is greater than this threshold, then it is considered that the striations are present on all the lines of the image, if the value max Ratio is less than this ratio, then the image does not possess any striations.
What is more complicated to determine happens when these two extrema are situated on either side of the threshold. In this case, the value of 1.5 no longer plays the role of satisfactory threshold, and it is necessary to find another threshold, differing according to the images. Our technique consists in choosing a threshold value s in such a way as to divide the lines of the image into two classes (with striation, it is assumed, and without striation, it is assumed) in such a way that the variances of the two classes are very close (this procedure is discussed hereinafter):

$$s = {arg min}_{x} \vert Var \{ Ratio ( i ) \vert Ratio ( i ) \leq t \} - Var \{ Ratio ( i ) \vert Ratio ( i ) > t \} \vert$$

If several thresholds are candidates to be the minimum, the lowest threshold will be taken.
It is possible to construct the image Line2_tmp which allocates a label to each of the lines of the input image by allocating, for all

$$y ∈ [ O , H ( Flat ) [ \text{:}$$

$${Line2}_{—} tmp ( y ) = \{ \begin{matrix}{Line}_{—} {NOTOK}_{—} NOSTRIE if Ratio ( y ) \leq s \\ {Line}_{—} OK otherwise \end{matrix}$$

We put Line_NOTOK_NOTSTRIATION=1.
The final image Line2, which allocates the definitive label of each of the lines of the input image, is a mixture between Line and a cleaned version of Line2_tmp. For all y∈[0,H(Flat)[: we put

$$Line 2 ( y ) = \{ \begin{matrix}Line ( y ) if {min}_{—} Ratio > 1.5 \\ min \{ Line ( y ) , {c}_{10}^{H} {φ}_{10}^{H} {γ}_{10}^{H} ( {Line2}_{—} tmp ) \} otherwise\end{matrix} \qquad ( 6 )$$

As explained previously, the image Line2 which allocates a label to each line of the input image is composed by mixing the information of Line and of Line2_tmp. If all the lines have a satisfactory variance ratio (greater than 1.5), then the striations are present over the entire height of the image and Line2 will be a copy of Line. Otherwise, if only certain lines have a satisfactory variance ratio, then Line2 is equal to a cleaned version of Line2_tmp except for the lines comprising too many outlier values, where the label Line_NOTOK_PNM is recopied (this operation is carried out by virtue of using the minimum);
The cleaning of Line2_tmp is performed by virtue of an opening, followed by a closing. However, it is realized in the images partially comprising striations that the latter do not all come to a stop on the same line: they peter out gradually, and do not disappear at the same lines. For this reason, an erosion of Line2_tmp is performed so as to widen the labels of the striation-less lines and to include, as a precaution, these “fuzzy” zones as striation-less lines.

The step of evaluating the number of striations on each line is preferentially performed in the following manner:
The variance is calculated of each of the columns of an input image Input which is, according to the embodiment, the image rendered flat Flat or the thresheld image Threshold. This calculation is performed by excluding, by virtue of Line2, the elements situated on lines possessing no striations. Furthermore, an erosion of the elements of Line2 is performed beforehand so as to distance the valid line labels from these zones:

Var_col(x)=Var(Input(x,y)|C₁₀^{H}(Line2(y)=Line_OK)
The image Var_col thus obtained is a one-dimensional image of the same size as the width of the images input. It is found that this image possesses a pattern that repeats as many times as there are striations in the image. A Fourier analysis of this image Var_col will then be performed to find the number of present striations on each line of the image. This calculation is as follows:

F=fft(fft(γ₁₀^{H}φ₁₀^{H}(Var_col)))
The size of the image F is equal to the largest power of two that is strictly less than L(Input) plus 1. Thus, for images 40 000 pixels wide, F has 32769 pixels. The image F is such that a spike on F(1000) signifies that there is, in the image, a pattern referencing itself every 1000 pixels. Consequently, it is useful to search for the spikes of E However, beforehand, the image is cleaned with an opening and a closing as follows:

F2=γ₁₀^{H}φ₁₀^{H}(F)
It is found that the structure of F2 is often the same whatever the input image: in a first third of the image, interesting oscillations are observed placed on a carrier signal, then the signal remains flat, dips towards half the image, and climbs back a little to remain flat in the last half. We shall therefore search for the minimum of the image after the first third, and place Os after this minimum, to obtain an image F3 as follows:

$$m = {arg min}_{x} \{ F 2 ( x ) \vert x \geq \frac{1}{2} L ( F 2 ) \}$$

$$F 3 ( x ) = \{ \begin{matrix}F 2 ( x ) if x \leq m \\ 0 otherwise \end{matrix}$$

A geodesic reconstruction of an image D in F3 is performed thereafter so as to recover the carrier signal that can then be removed. The image D is an image of the same size as the image F3, having as value at all the points except at the abscissa 0 where it equals F3(0).

$${p}_{m} ax = {arg max}_{x} F 4 ( x )$$

We then search for the position of the maximum of F4:
   It has been found that this maximum did not always represent the spatial period of the striations in the image. Indeed, it is necessary to take account of the phenomenon of harmonics in the image. For this purpose, we shall test fractions of the previously determined maximum, and search for a maximum pₙ of F4 in a certain neighbourhood Rn as follows:

$${R}_{n} = \{ x ∈ [ 0 , L ( F 4 ) ] \} \vert x - ⌊ \frac{P max}{n} ⌋ \vert \leq 100 \}$$

$${p}_{n} = {arg max}_{x ∈ {R}_{n}} F 4 ( x )$$

The set Nb_striation is then constructed, which contains all the candidates for the number of striations in the image:

$${Nb}_{—} Striation \{ [ \frac{L ( Input )}{{p}_{n}} ] \vert n ∈ [ 1 , 10 ] ⋂ N and L 4 ( {p}_{n} ) \geq 0.3 * L 4 ( {p}_{max} ) \} \qquad ( 7 )$$

The step of detecting the best candidates of the binary image is performed as follows:
Let C be the set of the adjoining components of Threshold; C′ the set of the elements of C which appear on at least 20 lines labelled as valid, and let S be the sequence of the elements of C′ sorted by decreasing size. We then have:

$$\{ \begin{matrix}For all k ∈ [ 1 , q ] , \\ {C}_{k} ∈ {C}^{′} ↔ \vert \{ l ∈ [ ystart ( {C}_{k} ) , yend ( {C}_{k} ) ] \vert Line 2 ( l ) = {Line}_{—} OK \} \vert \geq 20\end{matrix} \\ \{ \begin{matrix}For all i ∈ [ 1 , p ] , {S}_{i} ∈ {C}^{′} \\ For all i , j ∈ [ 1 , p ] , i < j ↔ \vert {S}_{i} \vert \geq \vert {S}_{1} \vert and {S}_{i} \neq {S}_{j}\end{matrix}$$

The set Candidate is then constructed by adding the elements of S if they are not in conflict with the elements already added to Candidate. Accordingly, a series of set R is constructed:

$${R}_{0} = 0 \\ {R}_{1} = \{ \begin{matrix}{R}_{i - 1} ⋃ \{ {S}_{i} \} if , for all j ∈ \vert ystart ( {S}_{1} ) , yend ( {S}_{i} ) \vert , \\ {nb}_{—} {comp}_{Thresh} ( {R}_{i - 1} , j ) < {nb}_{—} striation \\ {R}_{i - 1} otherwise \end{matrix} \\ Candidate = {R}_{k} \qquad ( 8 )$$

Finally, the present invention proposes a method implementing a certain number of original characteristics with respect to the solutions known from the prior art.

Thus, the means making it possible to perform a detection of the lines of the image where patterns are present are different from the known solutions, since the principle consisting in taking a mask of pixels that are candidates to belong to patterns, and in observing how the variance (calculated by excluding the elements of this mask) evolves as a function of the expansion of this mask, is original. Indeed, in the present invention, a search is conducted for relief elements which cause a projected shadow on the image, and the lines of the image possessing patterns are detected by attempting to detect the lines possessing a cast shadow.

Moreover, the present invention is aimed at proposing a method making it possible to divide the lines of the image into two categories: those where patterns are present, and those not possessing any. It has been found that the known solutions, namely the conventional approach consisting in minimizing the intra-class variance or in maximizing the inter-class variance did not work (in particular since the classes can have large variances). In the present invention, use is made of means consisting in equalizing the variances of the classes with the aid of an algorithm in linear time, thereby making it possible to remedy the drawback of the known solutions.

Furthermore, the scheme for counting the patterns, making it possible to ascertain how many patterns are normally present on the image in the absence of any defect comprises two inventive elements:
The first resides in the fact of carrying out a Fourier transform not on each line of the image, as presented in the known solutions, but on a signal in one dimension, which signal is representative of the lines of the image. This signal is obtained by calculating the variance of each column of the image: by virtue of the relief of the patterns and their cast shadow, a signal with the same period as the patterns of the image is obtained. This solution makes it possible to decrease the calculation times implemented.
The second element stems from the fact of carrying out morphological operations on the results of the Fourrier transform so as to clean it of parasitic elements which could falsify the result obtained.
Finally, a method according to the invention implements, for selecting the best candidate components that could belong to a striation, a series of operations of placement and then removal of the candidates while decreasing the constraints on their position as one proceeds. This process of decreasing the constraints as one proceeds runs counter to all the solutions of the prior art which generally consist in increasing the constraints with time.

1-8. (canceled)

9: A method of segmenting an image of a manufactured object, which has an external surface that exhibits relief patterns, into a first zone that includes patterns and a second zone that does not include patterns, the method comprising:
a thresholding step of transforming a grey-level image of the object into a binary image;
a line evaluation step of evaluating a number of patterns on each line of a plurality of lines of the binary image; and
a pattern determination step of, based on results of the line evaluation step, determining a number of patterns in the binary image and determining a first set of pixels of the binary image, wherein the first set of pixels represents patterns in the binary image.

10: The method according to claim 9, further comprising, before the thresholding step, a flattening step of obtaining a flattened grey-scale image, wherein the grey-scale image transformed in the thresholding step is the flattened grey-scale image.

11: The method according to claim 9, wherein the flattening step includes detecting a carrier signal on which patterns lie.

12: The method according to claim 9, further comprising, before the line evaluation step, a line detection step of detecting in the binary image the plurality of lines, which include patterns.

13: The method according to claim 10, further comprising, before the line evaluation step, a line detection step of detecting in the binary image the plurality of lines, which include patterns.

14: The method according to claim 11, further comprising, before the line evaluation step, a line detection step of detecting in the binary image the plurality of lines, which include patterns.

15: The method according to claim 9, further comprising:
a re-evaluation step of re-evaluating the number of patterns in the binary image, to obtain a re-evaluated number of patterns; and
a pixel removal step of filtering the first set of pixels as a function of the re-evaluated number of patterns, to obtain a second set of pixels of the binary image.

16: The method according to claim 10, further comprising:
a re-evaluation step of re-evaluating the number of patterns in the binary image, to obtain a re-evaluated number of patterns; and
a pixel removal step of filtering the first set of pixels as a function of the re-evaluated number of patterns, to obtain a second set of pixels of the binary image.

17: The method according to claim 11, further comprising a space filler step of filling empty spaces of the binary image, to obtain a third set of pixels of the binary image.

18: The method according to claim 17, further comprising a supernumerary removal step of eliminating supernumerary components from the third set of pixels, to obtain a fourth set of pixels of the binary image representing patterns.

19: The method according to claim 9, further comprising, before the thresholding step, a filtering step of cleaning the grey-level image with morphological filters.

20: The method according to claim 10, further comprising, before the thresholding step, a filtering step of cleaning the grey-level image with morphological filters.

21: The method according to claim 11, further comprising, before the thresholding step, a filtering step of cleaning the grey-level image with morphological filters.

22: The method according to claim 12, further comprising, before the thresholding step, a filtering step of cleaning the grey-level image with morphological filters.

23: The method according to claim 15, further comprising, before the thresholding step, a filtering step of cleaning the grey-level image with morphological filters.

24: The method according to claim 17, further comprising, before the thresholding step, a filtering step of cleaning the grey-level image with morphological filters.

25: The method according to claim 18, further comprising, before the thresholding step, a filtering step of cleaning the grey-level image with morphological filters.

26: The method according to claim 9, wherein the object is a tire.

27: The method according to claim 26, further comprising a defect determination step of determining a variance between a result of the pattern determination step and predetermined data for a normal tire.
